(19) United States
(12) Patent Application Publication
(10) Pub. No.: US 2022/0109384 A1
(43) Pub. Date: Apr. 7, 2022

(54) HYBRID TYPE ENERGY HARVESTER

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Jin Ho Hwang, Cheonan-si (KR); Ji Ah Kim, Seoul (KR); Min Ho Cho, Suwon-si (KR); Pukar Maharjan, Seoul (KR); Jae Yeong Park, Seoul (KR); Hyun Ok Cho, Seoul (KR)

(21) Appl. No.: 17/375,677

(22) Filed: Jul. 14, 2021

(30) Foreign Application Priority Data
Oct. 7, 2020 (KR) 10-2020-0129439

(51) Int. Cl. H02N 1/04; H02N 1/00

(52) U.S. Cl. CPC H02N 1/04; H02N 1/004

(57) ABSTRACT

The hybrid type energy harvester includes a coil part configured to cover at least a portion of an outer surface of a housing, a triboelectric charging part located in at least a portion of an inner side of the housing, an electrode part located in at least a portion between the housing and the triboelectric charging part, and a magnetic body located inside the housing and moving by being adjacent to the coil part and the triboelectric charging part.

### CROSS REFERENCE TO RELATED APPLICATIONS

The present application claims priority to Korean Patent Application No. 10-2020-0129439, filed Oct. 7, 2020, the entire contents of which is incorporated herein for all purposes by this reference.

### BACKGROUND

### Field

The present disclosure relates generally to a hybrid type energy harvester. More particularly, the present disclosure relates to a hybrid type energy harvester which can accumulate electric energy by generating induced electromotive force in a coil part and by generating triboelectricity in an electrode part in response to micro-vibration.

### Description of the Related Art

Generally, an energy harvester is located in an area in which vibration occurs and accumulates electric energy. The energy harvester includes a structure which generates the electric energy according to a relative motion between a magnet and a coil by external vibration energy. In this case, concerning the arrangement of the magnet, a conventional Halbach arrangement structure has been used

FIG. 1 is a view illustrating a conventional electromagnetic energy harvester having a Halbach arrangement structure. Referring to FIG. 1, in the Halbach arrangement structure, a plurality of magnets is configured to be repeatedly and alternately arranged by making magnetization directions thereof different from each other in relative to a wound coil part. The coil part means a spiral coil, the axial direction of the coil part means the extension direction of the coil part, and the radial direction of the coil part means a direction in which the radius of the coil part perpendicular to the axial direction thereof extends.

However, in the case of the conventional technology in which the electric energy is accumulated by using the electromagnetic energy harvester having a Halbach arrangement structure, the electromagnetic energy harvester does not generate high energy compared to the installation area or weight thereof.

In addition, in the case of the conventional harvester mounted to a vehicle, the magnitude of vibration generated inside a vehicle is very small and the frequency of the vibration is low, so the conventional harvester cannot produce the power of several mW to tens of mW or more which is necessary.

Recently, a vehicle includes various electric drive devices used therein, and is required to include a structurally very complex power application system so as to apply power to all of the drive devices by using a small number of batteries mounted to the inside of the vehicle.

Accordingly, there is a growing demand for directly applying power to sensors existing in various positions or to drive devices requiring electrical energy by using a miniaturized harvester.

### SUMMARY

Accordingly, the present disclosure has been made keeping in mind the above problems occurring in the related art, and the present disclosure is intended to propose a hybrid type energy harvester which is installed at a position at which vibration occurs and generates an induced electromotive force and triboelectricity.

In addition, the present disclosure is intended to propose a hybrid type energy harvester which is capable of producing several mW to tens of mW or more of power.

The objectives of the present disclosure are not limited to the objectives mentioned above, and other objectives of the present disclosure that are not mentioned can be understood by the following description, and can be more clearly understood by the embodiments of the present disclosure. Furthermore, the objectives of the present disclosure can be realized by means of the claims and combinations thereof.

In order to achieve the above objectives of the present disclosure, a hybrid type energy harvester includes the following components.

The hybrid type energy harvester according to a first embodiment of the present disclosure includes a coil part configured to cover at least a portion of an outer surface of a housing; a triboelectric charging part located in at least a portion of an inner side of the housing, an electrode part located in at least a portion between the housing and the triboelectric charging part, and a magnetic body located inside the housing and moving by being adjacent to the coil part and the triboelectric charging part.

In addition, the housing may be configured to have a hemispherical shape.

Furthermore, the housing may be configured to have a tube shape having a cycloidal section.

Additionally, the housing may be configured to have a cylindrical shape.

In addition, the triboelectric charging part may be configured as a negative triboelectric charging part or a positive triboelectric charging part.

Furthermore, the magnetic body may be configured to have a polarity opposite to a polarity of the triboelectric charging part.

Additionally, the negative triboelectric charging part may be made of one of PTFE, PVDF, PVC, and silicone, or a combination thereof.

In addition, the positive triboelectric charging part may be made of one of nylon, silk, and aluminum, or a combination thereof.

Furthermore, the surface of the triboelectric charging part may be configured to have a microstructure or a nanostructure.

Additionally, the electrode part may be configured to have an interdigitated electrode.

In addition, the magnetic body may be configured as an NdFeB neodymium magnet.

Furthermore, the energy harvester may further include a magnetic concentrator configured to be located at an outer side of the coil part and to cover the coil part.

Additionally, the magnetic concentrator may be made of a compound of PDMS and FeSiCr.

In addition, the electrode part may be made of a conductive object.

Furthermore, the electrode part may be made of copper or aluminum.

Additionally, the energy harvester may further include an elastic member located on a lower end of the housing and between the housing and a vibrating object.

The hybrid type energy harvester according to the embodiments of the present disclosure may have the following effects due to components to be described later, combination thereof, and usage relationships thereof.

The hybrid type energy harvester of the present disclosure has a small space and weight, thereby improving usability.

In addition, the hybrid type energy harvester of the present disclosure uses the effects of induced electromotive force and triboelectricity, thereby having high efficiency.

### BRIEF DESCRIPTION OF THE FIGURES

The above and other objectives, features, and other advantages of the present disclosure will be more clearly understood from the following detailed description when taken in conjunction with the accompanying drawings, in which:

FIG. 1 illustrates an electromagnetic energy harvester having a sequential arrangement structure according to a conventional technology;

FIG. 2A illustrates a hybrid type energy harvester configured to have a tube shape having a cycloidal section according to a first embodiment of the present disclosure;

FIG. 2B illustrates a coil part of the hybrid type energy harvester according to the first embodiment of the present disclosure;

FIG. 2C illustrates the electrode parts of the hybrid type energy harvester according to the first embodiment of the present disclosure;

FIG. 2D illustrates a triboelectric charging part of the hybrid type energy harvester according to the first embodiment of the present disclosure;

FIG. 3 illustrates the electric energy generation of the coil part according to the movement of a magnetic body according to the first embodiment of the present disclosure;

FIG. 4 illustrates electric energy generated from the triboelectric charging part according to the movement of the magnetic body according to the first embodiment of the present disclosure;

FIG. 5 illustrates a hybrid type energy harvester having housings configured to have hemispherical shapes according to a second embodiment of the present disclosure; and

FIG. 6 illustrates a hybrid type energy harvester configured as a cylindrical shape according to a third embodiment of the present disclosure.

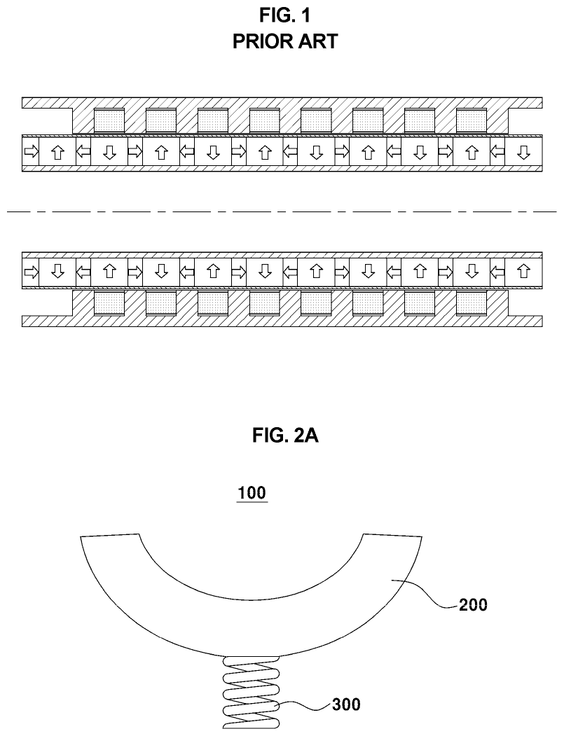

### DETAILED DESCRIPTION

Hereinbelow, the embodiments of the present disclosure will be described more in detail with reference to the accompanying drawings. The embodiments of the present disclosure may be variously modified, and the scope of the present disclosure should not be construed as being limited to the following embodiments. These embodiments are provided to more completely explain the present disclosure to those with average knowledge in the art.

In addition, terms such as “ . . . part”, “ . . . harvester”, and “ . . . device” described in the specification refer to units that process at least one function or operation, which may be embodied in hardware or software, or in the combination of hardware and software.

Hereinafter, the embodiments will be described in detail with reference to the accompanying drawings. In the description with reference to the accompanying drawings, the same or corresponding components are assigned the same reference numerals, and duplicate descriptions thereof will be omitted.

The present disclosure relates to a hybrid type energy harvester which is installed at a position at which vibration occurs and uses electric energy generated in a coil part located on a housing and in a triboelectric charging part located in the housing while a magnetic body moves along the inner side of the housing.

More preferably, the hybrid type energy harvester of the present disclosure may be mounted to a vehicle, and the mounting position of the energy harvester may be changed according to the shape of the housing.

The housing of the present specification may be manufactured in any one of a 3D printing method, an injection method, and an extrusion method.

Hereinbelow, in the specification of the present disclosure, each layer of the energy harvester constituting the hybrid type energy harvester having the housing configured to have a tube shape having a cycloidal section is described, but the shape of the housing is not limited to the following description.

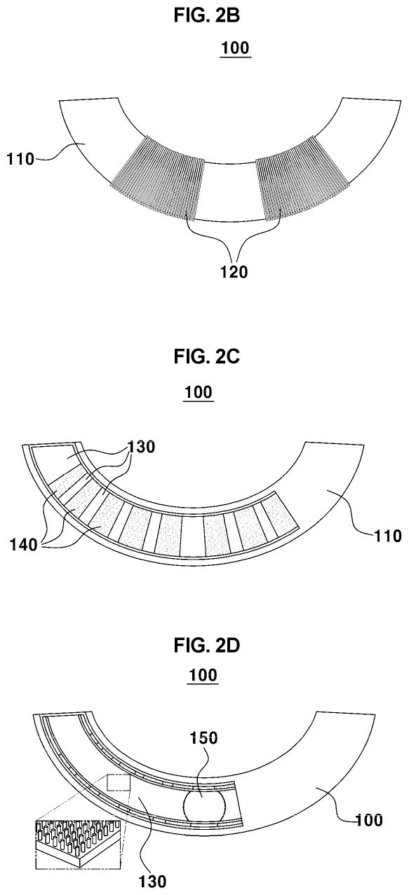

FIGS. 2A to 2D illustrate each layer of the hybrid type energy harvester 100 having the housing 110 configured to have the tube shape having a cycloidal section.

The hybrid type energy harvester 100 of the present disclosure includes the housing 110, the coil part 120 configured to cover at least a portion of the outer surface of the housing 110, an electrode part 140 located at a portion of the inner side of the housing 110, and the triboelectric charging part 130 located at the inner side of the electrode part 140. Furthermore, the hybrid type energy harvester may include a magnetic concentrator 200 configured to cover the outer surfaces of the coil part 120 and the housing 110. More preferably, the triboelectric charging part 130 of the present disclosure is made of a PTFE material and may be configured as a dielectric which generates negative charges.

In addition, the hybrid type energy harvester may further include an elastic member 300 provided on the outer surface of the housing 110, the elastic member being coupled to a vibrating object and located between the housing and the vibrating object. The elastic member 300 may be configured to increase vibration transmitted from the vibrating object and transmit the increased vibration to the housing 110.

The hybrid type energy harvester includes the magnetic body 150 configured to be located and move inside the housing 110 by being in contact with the triboelectric charging part 130. More preferably, the magnetic body 150 of the present disclosure is configured as an NdFeB neodymium magnet to have a spherical shape. According to the vibration transmitted to the hybrid type energy harvester 100, the magnetic body 150 having a spherical shape is configured to move along the inner side of the housing 110 in contact with the triboelectric charging part 130.

When the magnetic body 150 moves along the inner side of the housing 110, the coil part 120 configured to cover at least a portion of the housing 110 is configured to allow an induced electromotive force to be generated therein. That is, relative to the coil part 120, a distance between the magnetic body 150 and the coil part 120 is changeable, and the coil part 120 is configured to allow induced current to be conducted thereto.

Furthermore, the function of a triboelectric nanogenerator may be performed between the triboelectric charging part 130, the electrode part 140, and the magnetic body 150. That is, the triboelectric charging part 130 and the magnetic body 150 are configured to have different polarities, and when the magnetic body 150 moves by being in contact with the triboelectric charging part 130, the electrode part covering the outer side of the triboelectric charging part 130 is configured to have a polarity different from the polarity of the magnetic body 150 such that electric energy is generated.

Accordingly, in the hybrid type energy harvester of the present disclosure, according to the movement of one magnetic body 150, the induced electromotive force is generated in the coil part 120, and the magnetic body 150, the electrode part 140 and the triboelectric charging part 130 as the triboelectric nanogenerator are configured to generate electric energy.

To summarize, the hybrid type energy harvester of the present disclosure has the housing 110 including one magnetic body 150, and is configured to harvest electric energy by the induced electromotive force generated by the movement of the magnetic body 150 occurring due to vibration transmitted to space inside the housing 110 and by the function of the triboelectric nanogenerator.

FIG. 2B illustrates the coil part 120 located on at least a portion of the outer surface of the housing 110.

According to a first embodiment of the present disclosure, the housing 110 having a shape of a cycloidal section includes the coil part 120 located on the outer surface of the housing 110 by being wound thereon. More preferably, the coil part 120 located on the housing 110 having the shape of a cycloidal section is configured to have opposite sides thereof symmetrical to each other in relative to the middle part of the housing.

According to a second embodiment of the present disclosure, the hybrid type energy harvester may include a coil part 1200 located on each of the upper end part of an upper housing 1100 and of the lower end part of a lower housing 1100, the housings being configured to have hemispherical shapes, and according to a third embodiment of the present disclosure, multiple coil parts 2200 are configured to be located on the outer surface of a housing 2100 having a cylindrical shape such that a predetermined interval is defined between coil parts 120 adjacent to each other.

When the magnetic body 150 moves along the inner side of the housing 110 on which each of the coil parts 120 is located, the induced electromotive force is generated in the coil part 120, and the generated electric energy is transferred to an electric drive device through electric wires connected to the coil part 120 to be used as power of the drive device, or is used to charge a separately mounted battery.

The magnetic concentrator 200 is configured to be located at the outer side of the coil part 120 and to concentrate a magnetic flux on the coil part 120 when the induced electromotive force is generated. More preferably, the magnetic concentrator 200 may be made of the compound of polydimethyl siloxane (PDMS) and FeSiCr.

The magnetic concentrator 200 is configured to concentrate the magnetic flux generated according to the movement of the magnetic body 150 on the coil part, and increases the efficiency of electric energy generated by the induced electromotive force.

FIGS. 2C and 2D illustrate the configurations of the electrode part 140 and the triboelectric charging part 130 in which electric energy is generated by triboelectricity.

When the magnetic body 150 moves along the triboelectric charging part 130 located inside the housing 110, the electric energy is generated in the electrode part 140 located at at least a portion between the triboelectric charging part 130 and the housing 110. That is, the magnetic body 150 and the triboelectric charging part 130 are configured to have polarities different from each other, and when the magnetic body 150 passes by a position adjacent to the electrode part 140, the electrode part 140 is configured to have a polarity different from the polarity of the magnetic body 150. Accordingly, electric energy is generated due to the difference of polarities applied to conductive electrodes adjacent to each other.

More preferably, in the housing having the shape of a cycloidal section according to the first embodiment of the present disclosure, an interval between the electrode parts 140 is defined according to the direction of the movement of the magnetic body 150. In the third embodiment of the hybrid type energy harvester of the present disclosure including the housing having a cylindrical shape, the electrode parts 2400 may be located by being adjacent to each other to have an interval therebetween in a vertical direction by corresponding to the vertical movement of the magnetic body 2500. Alternatively, in the second embodiment of the hybrid type energy harvester of the present disclosure including the housings 110 having hemispherical shapes, electrode parts 1400 may be located to have vertical and horizontal intervals therebetween by corresponding to the movement of the magnetic body 1500 in the height and width directions of the housings.

In addition, the electrode part 140 of the present disclosure may be configured to have an interdigitated electrode and, as a conductive object, may be made of copper or aluminum. The electrode parts 140 can generate positive and negative charges alternately, and are configured to have polarities changing according to the position of the magnetic body 150.

The triboelectric charging part 130 of the present disclosure may be configured as a negative triboelectric charging part 130 or a positive triboelectric charging part 130, and the magnetic body 150 corresponding to the triboelectric charging part 130 is configured to have a polarity opposite to the polarity of the triboelectric charging part 130.

In the present disclosure, the positive triboelectric charging part 130 and a positive magnetic body 150 may be configured as a dielectric such as nylon, silk, and aluminum, and the negative triboelectric charging part 130 and a negative magnetic body 150 may be configured as a dielectric such as polytetrafluoroethylene (PTFE), polyvinylidene fluoride (PVDF), polyvinyl chloride (PVC), and silicon.

The triboelectric charging part 130 may have a microstructure or a nanostructure formed on a surface thereof facing the magnetic body 150, and is configured to maximize a triboelectric effect by increasing a contact area between the magnetic body 150 and the triboelectric charging part 130.

More preferably, according to the embodiment of the present disclosure, the inner surface of the triboelectric charging part 130 may be configured to have the microstructure or the nanostructure.

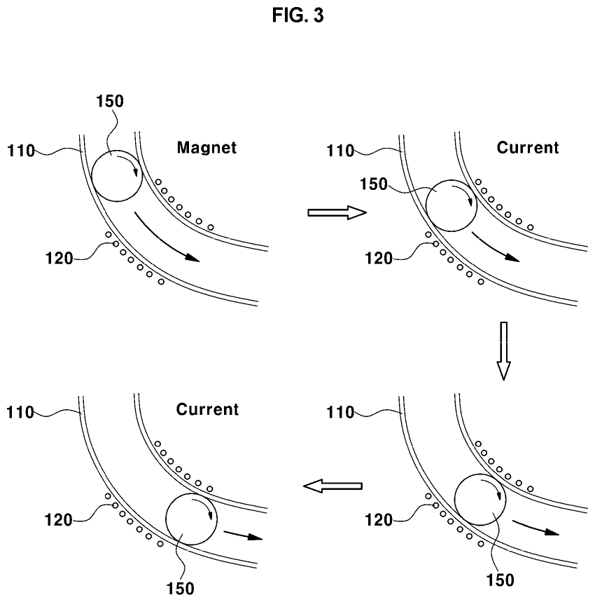

FIG. 3 illustrates electric energy generated between the magnetic body 150 and the coil part 120 according to the first embodiment of the present disclosure.

The coil part 120 is located on the outer surface of the housing 110, and when the magnetic body 150 moves inside the housing 110 on which the coil part 120 is located, the induced electromotive force is generated in the coil part 120. That is, the coil part 120 is configured to be wound on the outer surface of the housing 110 having a cylindrical shape such that the induced current is applied to the coil part 120 in response to the change of the magnetic flux of the magnetic body 150.

The movement of the magnetic body 150 is performed by vibration applied to the hybrid type energy harvester 100, and the magnetic body 150 is configured to continuously move in the height direction of the housing 110. The coil part 120 corresponding to the magnetic body is configured to be positioned on the outer surface of the housing 110 at a position higher by a predetermined interval than the lowest point of the housing 110. Additionally, the coil part 120 is configured to have the opposite sides thereof symmetrical to each other such that electric energy is generated at the opposite sides of the housing 110 due to the induced current generated during the movement of the magnetic body 150.

The induced current (the induced electromotive force) generated according to the movement of the magnetic body 150 is calculated by the following equation:

$$Induced electromotive force = - N \frac{Δ ( BA )}{Δ t}$$

(where N: the number of coil windings, B: the magnetic flux density of the magnetic body, A: the cross-sectional area of a coil,

$$\frac{Δ B}{Δ t} \text{:}$$

the change rate of a magnetic field).

That is, according to the number and cross-sectional area of coils wound on the housing 110, the magnetic flux density of the magnetic body 150, and the change rate of a magnetic field due to change in distance between the magnetic body 150 and the coils, the hybrid type energy harvester 100 generates the induced electromotive force.

In addition, the hybrid type energy harvester may include the elastic member 300 located on the lower end of the housing 110 and between the vibrating object and the housing 110, wherein the elastic member 300 can increase vibration introduced therethrough.

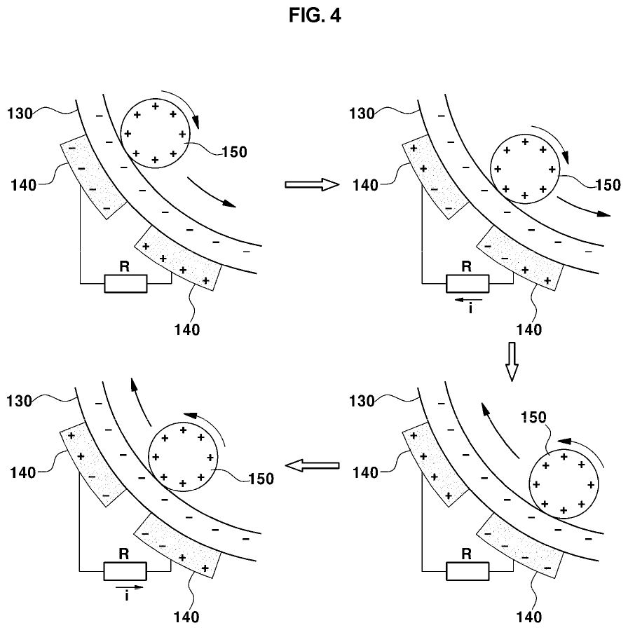

FIG. 4 illustrates the configurations of the triboelectric charging part 130 and the electrode parts 140 located on the inner surface of the housing 110, and illustrates the changes of the polarities of the triboelectric charging part 130 and the electrode parts 140 generating triboelectric energy due to magnetic body 150 moving inside the housing 110.

As illustrated in FIG. 4, the magnetic body 150 is configured to move in the same way as the movement of the magnetic body in FIG. 3, and allows the triboelectric energy to be generated from the triboelectric charging part 130 with which the magnetic body 150 is in contact and from each of the electrode parts 140 located between the triboelectric charging part 130 and the housing 110.

The generated triboelectric energy is calculated by the following equation:

$$Voc = \frac{σ x}{ɛ 0 ( l - x )} \frac{d 2}{ɛ r 2}$$

(where σ: the surface charge density of the triboelectric charging part, x: the distance of the magnetic body introduced to the triboelectric charging part relative to an end of the triboelectric charging part, εr2: the dielectric constant of a dielectric, εO: the dielectric constant of a vacuum dielectric, l: the length of the triboelectric charging part, d2: the diameter of the triboelectric charging part).

Accordingly, the magnetic body 150 is configured to generate the triboelectric energy while moving by being in contact with the inner surface of the triboelectric charging part 130.

In the first embodiment of the present disclosure, the magnetic body 150 is made of one of nylon, silk, and aluminum, or a combination thereof to have a positive polarity, and the triboelectric charging part 130 is made of one of polytetrafluoroethylene (PTFE), polyvinylidene fluoride (PVDF), polyvinyl chloride (PVC), and silicone, or the combination thereof to have a negative polarity.

Accordingly, the magnetic body 150 and the triboelectric charging part 130 are maintained to have polarities different from each other, and the magnetic body 150 is configured to move inside the housing 110 in which the electrode parts 140 are located. The electrode parts 140 are configured such that electricity is conducted between electrodes thereof adjacent to each other, and an electrode located at a position close to the magnetic body 150 is configured to switch to a polarity opposite to the polarity of the magnetic body 150. Accordingly, the magnetic body 150 is configured to pass by sequentially positioned electrodes, and each electrode of each of the electrode parts 140 is changed to have a negative polarity at a position close to the magnetic body 150, whereby friction currents are induced to be generated between the electrodes adjacent to each other.

That is, according to the first embodiment of the present disclosure, when the magnetic body 150 located inside the housing 110 having the shape of a cycloidal section moves from the upper end of the housing to the lower end thereof, the electrode of the electrode part 140 close to the upper end is configured to have a polarity opposite to the polarity of the magnetic body 150. When the magnetic body 150 moves away from the electrode close to the upper end, each of the electrodes adjacent to each other sequentially has a polarity opposite to the polarity of the magnetic body 150, and the polarity of the upper end is configured to have the same polarity as the polarity of the magnetic body 150. Accordingly, the hybrid type energy harvester is configured to generate the triboelectric energy in response to the change of the polarity of the electrode part 140.

To summarize, FIGS. 3 and 4 illustrate the hybrid type energy harvester 100, in which when one magnetic body 150 moves inside the housing 110, induced current is generated in the coil part 120, and the triboelectric energy is generated in the electrode part 140.

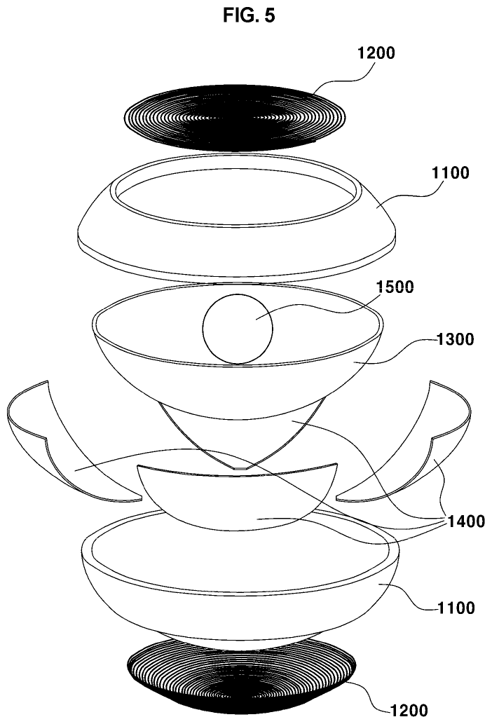

FIG. 5 illustrates the hybrid type energy harvester 100 including housings 1100 having hemispherical shapes according to the second embodiment of the present disclosure.

The hybrid type energy harvester according to the second embodiment of the present disclosure is configured to have components having the same physical properties and features as the components constituting the hybrid type energy harvester according to the first embodiment described above. Hereinafter, description will be made by focusing on a differentiated configuration corresponding to the shape of each of the housings.

The hybrid type energy harvester 100 including the housings 1100 having hemispherical shapes includes the coil part 1200 located on each of the upper and lower ends thereof, wherein a triboelectric charging part 1300 is configured to be located inside the housings. The electrode parts 1400 are configured to be located between the triboelectric charging part 1300 and the housings 1100, and has substantially the same configuration as the electrode part 140 disclosed in the first embodiment.

In the second embodiment of the present disclosure, the electrode parts 1400 may be configured to have a predetermined interval therebetween in a height direction, and each adjacent electrode thereof is configured to be electroconductive to each other. That is, the electrode parts 1400 are configured to have electrodes adjacent to each other such that the generation of triboelectricity between the electrodes is induced when a magnetic body 1500 moves between the electrodes.

Furthermore, the coil part 1200 is configured to be located on each of the upper housing and the lower housing such that induced current is generated while the magnetic body 1500 moves inside the housings 1100 in a height direction thereof.

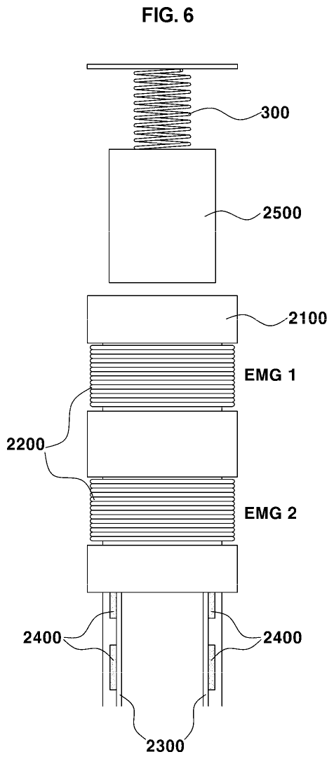

FIG. 6 illustrates the hybrid type energy harvester 100 including the housing 2100 configured as a cylindrical shape and a magnetic body 2500 configured to move in a height direction along the inner side of the housing having the cylindrical shape according to the third embodiment of the present disclosure.

According to vibration applied to the magnetic body, the magnetic body 2500 moves by being in contact with a triboelectric charging part 2300 located inside the housing having a cylindrical shape. Accordingly, by using the triboelectricity generated in this case, the electrode parts 2400 located on the outer side of the triboelectric charging part 2300 are configured to generate electric energy.

Furthermore, when the magnetic body 2500 moves along the inner surface of the housing, the coil part 2200 located on the outer surface of the housing 2100 is configured to generate the induced electromotive force.

That is, the hybrid type energy harvester 100 of the present disclosure including the housing having each of different shapes according to the embodiments generates the induced electromotive force and the triboelectric energy by using the same components. The hybrid type energy harvester 100 is connected to an electric drive device or battery such that the generated electric energy is transmitted thereto.

In addition, the hybrid type energy harvester of the present disclosure may be connected to a predetermined position of a vehicle, and is configured to change vibration generated in the vehicle to electric energy such that the changed electric energy is transmitted to a black box, a sensor part and an electric device located in the vehicle.

The detailed description above is illustrative of the hybrid type energy harvester of the present disclosure. In addition, the above description illustrates and describes the exemplary embodiments of the present disclosure, and the components of the hybrid type energy harvester of the present disclosure may be variously combined and modified to be used in various environments. That is, changes or modifications may be made within the scope of the concept of the present disclosure disclosed in the present specification, and within a scope equivalent to the disclosed content and/or the scope of the skill or knowledge of the art. The described embodiments describe the best mode for realizing the technical spirit of the present disclosure, and various changes required in the specific application fields and uses of the hybrid type energy harvester of the present disclosure are possible. Accordingly, the detailed description of the present disclosure is not intended to be limited to the disclosed embodiments. In addition, the scope of the appended claims should be construed as including other embodiments.

1. A hybrid type energy harvester comprising:
a coil configured to cover at least a portion of an outer surface of a housing;
a triboelectric charging part positioned in at least a portion of an inner side of the housing;
an electrode positioned at least partially between the housing and the triboelectric charging part; and
a magnetic body positioned inside the housing and moving by being adjacent to the coil part and the triboelectric charging part.

2. The energy harvester of claim 1, wherein the housing has a hemispherical shape.

3. The energy harvester of claim 1, wherein the housing has a tube shape having a cycloidal section.

4. The energy harvester of claim 1, wherein the housing has a cylindrical shape.

5. The energy harvester of claim 1, wherein the triboelectric charging part is a negative triboelectric charging part or a positive triboelectric charging part.

6. The energy harvester of claim 5, wherein the magnetic body has a polarity opposite to a polarity of the triboelectric charging part.

7. The energy harvester of claim 5, wherein the negative triboelectric charging part is made of one of PTFE, PVDF, PVC, and silicone, or a combination thereof.

8. The energy harvester of claim 5, wherein the positive triboelectric charging part is made of one of nylon, silk, and aluminum, or a combination thereof.

9. The energy harvester of claim 1, wherein a surface of the triboelectric charging part has a microstructure or a nanostructure.

10. The energy harvester of claim 1, wherein the electrode part has an interdigitated electrode.

11. The energy harvester of claim 1, wherein the magnetic body has an NdFeB neodymium magnet.

12. The energy harvester of claim 1, further comprising:
a magnetic concentrator positioned at an outer side of the coil and covering the coil.

13. The energy harvester of claim 12, wherein the magnetic concentrator is made of a compound of PDMS and FeSiCr.

14. The energy harvester of claim 1, wherein the electrode is made of a conductive object.

15. The energy harvester of claim 14, wherein the electrode is made of copper or aluminum.

16. The energy harvester of claim 1, further comprising:
an elastic member positioned on a lower end of the housing and between the housing and a vibrating object.
